(19) United States
(12) Patent Application Publication
(10) Pub. No.: US 2024/0300281 A1
(43) Pub. Date: Sep. 12, 2024

(54) REAR AIR CONDITIONER FOR VEHICLE

(71) Applicant: Hanon Systems, Daejeon (KR)

(72) Inventors: Tae Wan KIM, Daejeon (KR); Sae Dong EOM, Daejeon (KR)

(21) Appl. No.: 18/560,963

(22) PCT Filed: Nov. 23, 2022
(86) PCT No.: PCT/KR2022/018595

§ 371 Date: Nov. 15, 2023

(30) Foreign Application Priority Data
Nov. 30, 2021 (KR) 10-2021-0167869
Nov. 21, 2022 (KR) 10-2022-0156723

(51) Int. Cl. B60H 1/00

(52) U.S. Cl. CPC B60H 1/00028; B60H 1/00207; B60H 2001/00128; B60H 2001/002; B60H 2001/00242

(57) ABSTRACT

Disclosed is a rear air conditioner for a vehicle, which can improve the comfort of a rear seat in a vehicle by improving the temperature difference between a console vent and a B-pillar side while minimizing the increase in the temperature at the console vent side. The rear air conditioner for the vehicle is connected to a front air conditioner and supplies air conditioning airflow toward the rear seat of the vehicle, and comprises: a case of which one side is connected to the front air conditioner and the other side has a plurality of discharge ports for discharging the air into the interior of the vehicle; and an electric heater which is provided in the case and heats the air passing therethrough, wherein the electric heater is provided with a plurality of operating regions, of which at least one operates in linkage with an air conditioning mode.

### TECHNICAL FIELD

The present invention relates to a rear air conditioner for a vehicle, and more specifically, to a rear air conditioner for a vehicle, which is configured to be connected to a front air conditioner for the vehicle to discharge air to a console vent, a rear seat floor vent, and a B-pillar side.

### BACKGROUND ART

In general, an air conditioner for a vehicle is an apparatus for cooling or heating the interior of the vehicle by cooling or heating through the process of introducing outdoor air into the interior of the vehicle or circulating indoor air of the vehicle. Such an air conditioner for a vehicle includes an evaporator for a cooling action and a heater core for a heating action inside an air conditioning case, and selectively blows the air cooled by the evaporator or heated by the heater core toward parts of the interior of the vehicle.

For rear seat air conditioning in a vehicle, a rear air conditioner can be installed in a console side. FIG. 1 is a perspective view of a conventional rear air conditioner. Referring to FIG. 1, the air conditioner for a vehicle can independently control air flows of three zones (a driver's seat, a passenger seat, and a rear seat). The conventional rear air conditioner 10 is connected to a front air conditioner to receive conditioned air and discharge the conditioned air to the interior of the vehicle. The front air conditioner includes an air conditioning case, a cooling means, a heating means, a temperature door, and a mode door.

The air conditioning case has an air passage formed therein and a blower unit provided to forcibly blow air to the air passage. The cooling means and the heating means are sequentially installed inside the air conditioning case. The cooling means may be an evaporator, and the heating means may be a heater core. The temperature door is installed between the evaporator and the heater core to adjust the degree of opening of a cold air passage bypassing the heater core and a warm air passage passing through the heater core. The mode door adjusts the degree of opening of an air discharge port.

The rear air conditioner 10 has an air inlet which is formed on one side thereof and connected to the front air conditioner to introduce air, and a blower 30 is provided downstream of the air inlet. The rear air conditioner 10 includes a mode duct 20, which is connected to the downstream side of the blower 30 through a connection duct 12. The mode door is provided downstream of the blower 30 in an air flow direction inside the rear air conditioner 10.

Depending on the operation of the mode door, conditioned air selectively flows to the console vent 15 or the mode duct 20. The air discharged to the mode duct 20 selectively flows to a rear seat floor vent 13 or a B-Pillar 14 according to the operation of a door installed inside the mode duct 20. Meanwhile, the rear air conditioner 10 includes a PTC heater, which is an electric heater to improve the heating performance of the rear seat.

The conventional rear air conditioner 10 is set to discharge air toward the B-Pillar 14 only when the temperature upstream of the blower 30 is above a predetermined temperature, in order to prevent cold air from being discharged toward the B-Pillar 14 during winter.

In the conventional rear air conditioner 10, air is discharged toward the console vent 15 and the B-Pillar 14 in a vent mode or a bi-level mode. However, as air flows through the B-Pillar duct 19, due to a heat loss, there occurs a significant temperature difference between the console vent 15 and the B-Pillar 14. This results in a decrease in comfort of the rear seat of the vehicle.

In addition, when the PTC heater installed in the rear air conditioner 10 is operated at full heating, the discharge temperature at the B-Pillar 14 increases, but the discharge temperature at the console vent 15 also increases, so the temperature difference between the console vent 15 and the B-Pillar 14 is not improved, so comfort of the rear seat of the vehicle is also decreased.

### DISCLOSURE

### Technical Problem

Accordingly, the present invention has been made in view of the above-mentioned problems occurring in the related art, and it is an object of the present invention to provide a rear air conditioner for a vehicle, which can improve the comfort of a rear seat in a vehicle by improving the temperature difference between a console vent and a B-pillar side while minimizing the increase in the temperature at the console vent side.

### Technical Solution

To accomplish the above-mentioned objects, according to the present invention, there is provided a rear air conditioner for a vehicle, which is connected to a front air conditioner to supply conditioned air to a rear seat side in the vehicle, including: a case of which one side is connected to the front air conditioner, and which includes a plurality of discharge ports formed at the other side to discharge air into the interior of the vehicle; and an electric heater which is provided in the case to heat the air passing through the electric heater, wherein the electric heater includes a plurality of operating regions, and at least one of the plurality of operating regions operate according to air conditioning modes.

The discharge ports include a first discharge port and a second discharge port, the electric heater includes a plurality of heating parts, and in the air conditioning mode where air is simultaneously discharged to the first discharge port and the second discharge port, only the heating parts of the electric heater corresponding to a region near the second discharge port is operated.

The discharge ports include a first discharge port and a second discharge port which is formed below the first discharge port, and a backflow prevention means is provided to suppress that the air flowing toward the second discharge port downstream of the electric heater in an air flow direction flows back to the first discharge port side.

A partition wall is formed to extend in a direction parallel to the air flow direction at the rear end of the electric heater.

A mode door is provided inside the case to adjust the amount of air flowing to the first discharge port and the amount of air flowing to the second discharge port, and the partition wall is arranged between the electric heater and the mode door.

The partition wall is arranged above a middle portion of the electric heater in the vertical direction.

At a position where the end of the mode door faces the partition wall, the air passing through the electric heater is guided to the first discharge port and the second discharge port by the partition wall.

The case includes a mode door which adjusts the amount of air flowing to the first discharge port and the amount of air flowing to the second discharge port, and a control unit is provided to, in the air conditioning mode where air is simultaneously discharged to the first discharge port and the second discharge port, feedback a drive voltage value to a driving part of the mode door so that the mode door is closed more toward the first discharge port 107 than in other air conditioning modes.

The case includes a mode door which adjusts the amount of air flowing to the first discharge port and the amount of air flowing to the second discharge port, and a door seal is provided along the perimeter of the mode door to suppress the flow of air flowing from the bottom to the top.

The rear air conditioner for a vehicle further includes a case seal which is provided on the side of the case to fill a gap between the case and the mode door, wherein the case seal is partially formed only in the air passage directed to the side of the first discharge port.

The rear air conditioner for a vehicle further includes a tail seal which is provided on a rotational shaft of the mode door to fill a gap between the rotational shaft and the case.

In a vent mode or a bi-level mode, control is performed so that only some heating parts located at the bottom of the electric heater are operated, and the number of the operated heating parts is more than the number of non-operated heating parts.

A blower which blows air to the plurality of discharge ports is provided in the case, and the blower is arranged upstream of the electric heater in the air flow direction.

The electric heater is arranged in front of the plurality of discharge ports, and partially operates to heat only the air discharged to a specific discharge port among the plurality of discharge ports depending on the air conditioning mode.

In another aspect of the present invention, there is provided a rear air conditioner for a vehicle, which is connected to a front air conditioner to supply conditioned air to a rear seat side in the vehicle, including: a case of which one side is connected to the front air conditioner, and which includes a plurality of discharge ports formed at the other side to discharge air into the interior of the vehicle; an electric heater which is provided in the case to heat the air passing through the electric heater; and a control unit which controls a heating region of the electric heater differently according to air conditioning modes.

The plurality of discharge ports respectively have discharge ducts, and the lengths of the discharge ducts are formed to be different from each other.

The control unit controls to generate heat only in some region of the electric heater when air is simultaneously discharged to the plurality of discharge ports.

The heat generating region of the electric heater corresponds to the discharge port for which the length of the discharge duct is relatively long.

The control to generate heat only in some region of the electric heater is performed when an external air temperature is below a specific temperature, a battery voltage is above a specific volt, a blower is at a specific level or higher, and a target discharge temperature for the rear seat is above a specific temperature.

The control to generate heat only in some region of the electric heater is released when any one of the following conditions is met: a case in which the external air temperature is above the specific temperature, a case in which the battery voltage is below the specific volt, a case in which the blower is off (OFF) or at the lowest level, or a case in which the target discharge temperature for the rear seat is below the specific temperature.

### Advantageous Effect

The rear air conditioner according to the present invention can minimize the temperature increase of the air discharged to the console vent while increasing the temperature of the air discharged to the B-pillar vent. Therefore, the rear air conditioner according to the present invention can improve the comfort of the rear seat in the vehicle by improving the temperature difference between the console vent and the B-pillar side while minimizing the increase in the temperature at the console vent side.

### BRIEF DESCRIPTION OF THE DRAWINGS

FIG. 1 is a perspective view illustrating a conventional rear air conditioner.

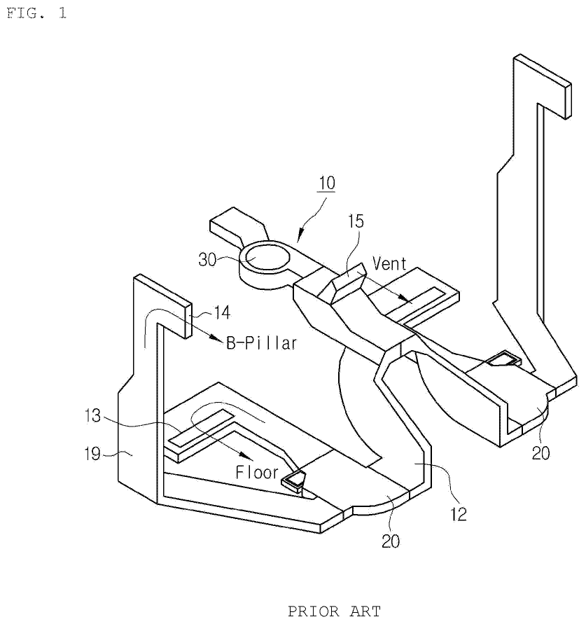

FIG. 2 is a perspective view illustrating a front air conditioner and a rear air conditioner according to an embodiment of the present invention.

FIG. 3 is a cross-sectional view taken along line A-A of FIG. 2.

FIG. 4 is a cross-sectional view illustrating a portion of the rear air conditioner according to an embodiment of the present invention.

FIG. 5 is a partially cross-sectional perspective view illustrating a portion of the rear air conditioner according to an embodiment of the present invention.

FIGS. 6 and 7 are diagrams illustrating a feedback control according to air conditioning modes of the rear air conditioner according to an embodiment of the present invention.

### MODE FOR INVENTION

Hereinafter, the technical configuration of a rear air conditioner for a vehicle will be described in detail with reference to the accompanying drawings.

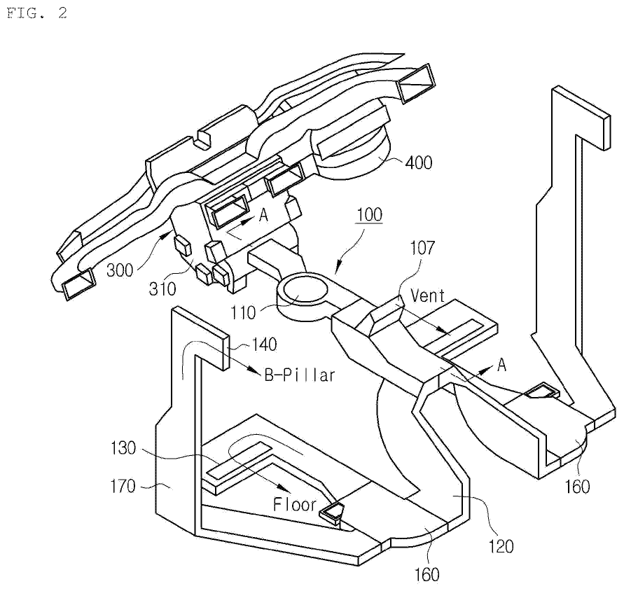

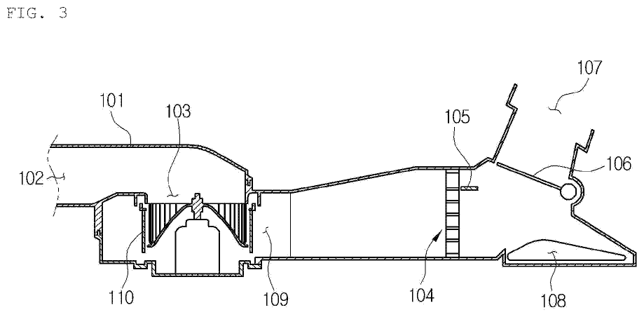

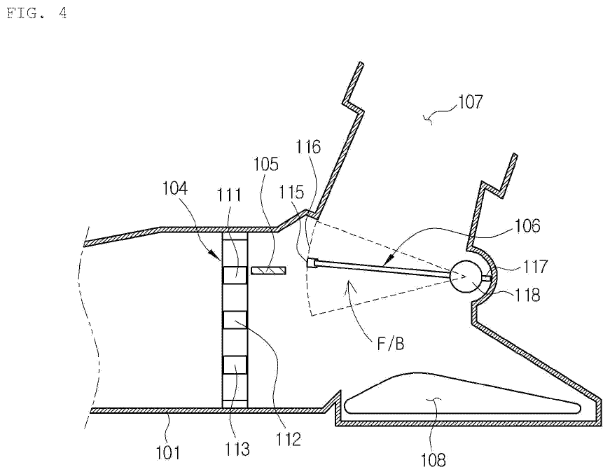

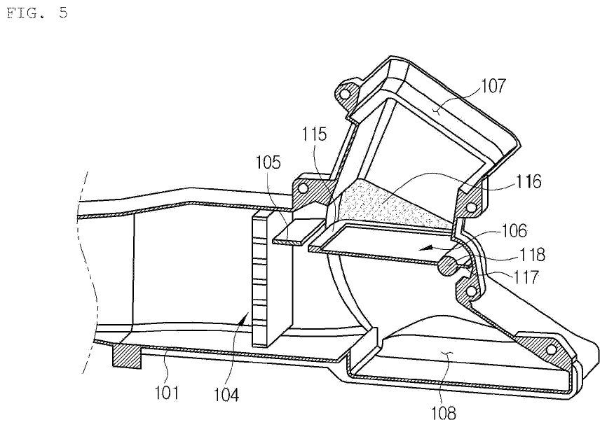

Referring to FIGS. 2 to 5, an air conditioner for a vehicle according to an embodiment of the present invention comprises a front air conditioner 300 and a rear air conditioner 100. The rear air conditioner 100 is connected to the front air conditioner 300 to receive conditioned air and discharge the conditioned air into the interior of the vehicle. The front air conditioner 300 includes a main case 310, a blower unit 400, a cooling means, a heating means, a temperature door, and a front seat mode door.

An air passage is formed inside the main case 310, an air inlet is formed at one side thereof, and a plurality of air discharge ports are formed at the other side thereof. The blower unit 400 is configured to selectively blow indoor or outdoor air into the air passage inside the main case 310. The cooling means and the heating means are sequentially installed inside the main case 310. The cooling means includes an evaporator, and the heating means may include a heater core.

The temperature door is installed between the evaporator and the heater core to control the degree of opening of a cold air passage which bypasses the heater core and a warm air passage which passes through the heater core, thereby adjusting the temperature of the air discharged into the interior of the vehicle. The front seat mode door adjusts the degree of opening of the plurality of air discharge ports. The front seat mode door includes a defrost door which adjusts the degree of opening of a defrost vent, a vent door which adjusts the degree of opening of a face vent, and a floor door which adjusts the degree of opening of a floor vent.

The rear air conditioner 100 is connected to one of the plurality of air discharge ports of the front air conditioner 300 to supply conditioned air cooled or heated by passing through the evaporator or the heater core to the rear seat side of the vehicle. The rear air conditioner 100 includes a case 101, a blower 110, an electric heater 104, and a mode door 106.

The case 101 has an inlet 102 formed at one side, and the inlet 102 is connected to the front air conditioner 300. In addition, a plurality of discharge ports are formed on the other side of the case 101 to discharge air into the interior of the vehicle. The conditioned air introduced through the inlet 102 from the front air conditioner 300 moves into the interior of the case 101.

The discharge ports of the case 101 include a first discharge port 107 and a second discharge port 108. The first discharge port 107 is connected to a console vent to discharge the conditioned air toward the passenger's face side. The second discharge port 108 is connected to a rear seat floor vent 130 for discharging the conditioned air toward the passenger's foot side, and is connected to a B-pillar vent 140 for discharging the conditioned air toward both upper sides in the vehicle width direction.

The blower 110 is arranged downstream of the inlet 102 of the case 101 in the air flow direction. The blower 110 includes a blower motor and a blower wheel, and can blow the conditioned air introduced from the inlet 102 up to the rear seats in the vehicle. A rotational shaft of the blower motor is arranged vertically, so that the blower wheel rotates horizontally. The air sucked into an intake port 103 formed above the blower 110 moves horizontally through an outlet 109 by the blower 110. The blower 110 is arranged upstream of an electric heater 104 in the air flow direction.

The rear air conditioner 100 includes a mode duct 160, which is connected to the downstream side of the blower 110 via a connection duct 120. A door for adjusting the amount of air flowing toward the rear seat floor vent 130 and the amount of air flowing toward the B-pillar vent 140 is provided inside the mode duct 160. In other words, the passage of the downstream side of the case 101 in the air flow direction is largely divided into two: one being the air passage heading toward the console vent through the first discharge port 107 opened at the upper portion of the case 101; and the other being the air passage heading toward the mode duct 160 through the second discharge port 108 opened at the lower portion of the case 101.

The air flowing into the mode duct 160 selectively flows toward the rear seat floor vent 130 or the B-pillar vent 140 side according to the rotational operation of the door. The air flowing toward the B-pillar vent 140 side moves along the B-pillar duct 170, which extends from the mode duct 160 in the vehicle width direction and then extends upward, and is discharged to the rear seat in the vehicle through the B-pillar vent 140.

Furthermore, the first discharge port 107 of the case 101 heading toward the console vent is located above the second discharge port 108 of the case 101 heading toward the B-pillar vent 140 and the rear seat floor vent 130. Additionally, the mode duct 160 extends from the second discharge port 108 of the case 101, heading toward the B-pillar vent 140 and the rear seat floor vent 130, through the connection duct 120, and then, the B-pillar duct 170 extends upward from the mode duct 160. At the upper end of the B-pillar duct 170, the B-pillar vent 140 is formed to discharge the conditioned air to the rear seat of the vehicle.

The electric heater 104 is provided in the case 101 to heat the air passing through the electric heater. In other words, the electric heater 104 is a heater which generates heat upon application of power, such as a PTC heater, and the air passing through the electric heater 104 is heated. The electric heater 104 has a plurality of operating regions, and the plurality of operating regions operate according to air conditioning modes. That is, in a first air conditioning mode of the rear air conditioner 100 according to an embodiment of the present invention, only a portion of the electric heater 104 operates. In this case, the first air conditioning mode is an air conditioning mode for discharging air toward the B-pillar vent 140 side, which is a vent mode or a bi-level mode.

That is, the electric heater 104 is arranged in front of the plurality of discharge ports, and partially operates to heat only the air discharged to a specific discharge port among the plurality of discharge ports depending on the air conditioning modes.

The mode door 106 is rotatably installed on the downstream side of the case 101 in the air flow direction. The mode door 106 is arranged downstream of the electric heater 104 in the air flow direction to adjust the amount of air flowing to the first discharge port 107 and the amount of air flowing to the second discharge port 108. Depending on the rotational operation of the mode door 106, the air passing through the electric heater 104 flows to the first discharge port 107 or to the second discharge port 108.

That is, the mode door 106 can close the first discharge port 107 and open only the second discharge port 108, so that all the air passing through the electric heater 104 can flow to the mode duct 160 and then can be discharged to the rear seat floor vent 130 or the B-pillar vent 140. Alternatively, the mode door 106 can close the second discharge port 108 and open only the first discharge port 107, so that all the air passing through the electric heater 104 can be discharged to the console vent. Alternatively, the mode door 106 can open both the first discharge port 107 and the second discharge port 108, so that the air passing through the electric heater 104 can be discharged to the console vent, the rear seat floor vent 130, or the B-pillar vent 140.

The electric heater 104 has a plurality of heating parts in the vertical direction. That is, the electric heater 104 includes a first heating part 111, a second heating part 112, and a third heating part 113. The first heating part 111, the second heating part 112, and the third heating part 113 may include positive temperature coefficient (PTC) elements, which generate heat when power is applied, and are sequentially arranged from the top to the bottom. The number of the heating parts can be appropriately increased or decreased in accordance with the size of the package.

In particular, in a specific air conditioning mode, only the heating parts of the electric heater 104 corresponding to a region near the second discharge port 108 are controlled to operate. The rear seat air conditioning unit 100 includes a control unit. That is, in the air conditioning mode where air is discharged simultaneously to both the first discharge port 107 and the second discharge port 108, the control unit controls only the heating parts of the electric heater 104 corresponding to the region near the second discharge port 108 to operate.

The control unit is connected to a driving part of the electric heater 104, and controls only some heating parts located at the bottom of the electric heater 104 to operate in the vent mode or bi-level mode. In this case, the control unit controls such that the number of operating heating parts is greater than the number of non-operating heating parts. The air conditioning mode where air is simultaneously discharged to both the first discharge port 107 and the second discharge port 108 can be a vent mode where the air flow ratio of the first discharge port 107 to the second discharge port 108 is 5:5, or a bi-level mode where the air flow ratio is 4:6.

That is, in the air conditioning mode where air is simultaneously discharged to both the first discharge port 107 and the second discharge port 108, the first heating part 111 does not operate, and only the second heating part 112 and the third heating part 113 operate. Therefore, the air passing through the electric heater 104, which passes relatively through the upper portion, flows to the first discharge port 107 without being heated by the first heating part 111, while the air passing relatively through the middle and lower parts is heated by the second heating part 112 and the third heating part 113 and flows to the second discharge port 108 at the lower portion.

The air discharged to the B-pillar vent 140 must pass through the B-pillar duct 170, so heat loss is inevitably incurred while the heated air passes through the B-pillar duct 170. As described above, when the control unit controls to operate only the lower two rows of the electric heater 104, hot air can be supplied only to the second discharge port 108, and head toward the B-pillar vent 140 side. Therefore, while the temperature of the air discharged to the B-pillar vent 140 can be increased, the amount of temperature increase of the air discharged to the console vent can be minimized.

Meanwhile, the rear air conditioner 100 according to an embodiment of the present invention includes a backflow prevention means. The backflow prevention means is provided on the downstream side of the electric heater 104 in the air flow direction, and suppresses the air flowing toward the second discharge port 108 from flowing back toward the first discharge port 107.

As described above, even if the control unit controls to operate only the lower two rows of the electric heater 104, air inevitably flows back from the bottom to the top because the lower air passage has greater air resistance than the upper air passage. The backflow prevention means minimizes the amount of air flowing back from the bottom to the top, thereby minimizing the decrease in the temperature of the air discharged to the second discharge port 108.

The backflow prevention means may be realized in the form of a partition wall, a seal, control of the degree of opening of a mode door, or a combination thereof.

That is, the rear air conditioner 100 includes a partition wall 105. The partition wall 105 is provided in the internal air passage of the case 101 and is formed to extend horizontally in a direction parallel to the air flow direction at the rear end of the electric heater 104. The partition wall 105 may be closely coupled to the rear end of the electric heater 104, or may be formed to integrally extend rearward from the electric heater 104. Alternatively, the partition wall 105 may be spaced very close to the rear end of the electric heater 104 and extend horizontally. The partition wall 105 extends to both sides of the case 101 in the vehicle width direction.

Since the partition wall 105 is provided at the rear end of the electric heater 104, upward movement of the lower air in the case 101 can be blocked or significantly reduced.

Furthermore, the partition wall 105 is arranged between the electric heater 104 and the mode door 106. Additionally, the partition wall 105 is positioned above the middle portion of the electric heater 104 in the vertical direction. Therefore, since the partition wall 105 is arranged between the electric heater 104 and the mode door 106, the air passing through the electric heater 104 is guided to the first discharge port 107 and the second discharge port 108, respectively, by the partition wall 105 at a position where the end portion of the mode door 106 faces the partition wall 105.

Therefore, as described above, in the specific air conditioning mode, when the heating parts of the electric heater 104 are partially controlled, the air flowing to the first discharge port 107 and the air flowing to the second discharge port 108 can be separated to further improve the air conditioning performance. Moreover, since the partition wall 105 is arranged on the upper side of the electric heater 104, the air in the lower air passage of the case 101 can be heated to a higher temperature.

Meanwhile, the rear air conditioner 100 includes a door seal 115. The door seal 115 extends along the perimeter of the mode door 106 to seal a gap between the case 101 and the mode door 106. The door seal 115 prevents the air in the lower air passage inside the case 101 from escaping to the upper air passage through the gap between the case 101 and the mode door 106, thereby suppressing the flow of air moving from the bottom to the top. Furthermore, the door seal 115 can further reduce the amount of air leaking from the bottom to the top by filling the gap between the partition wall 105 and the door seal 115 at the position facing the partition wall 105.

In addition, a case seal 116 may be further provided on the side of the case 101. The case seal 116 fills a gap between the case 101 and the mode door 106. The case seal 116 functions to reduce the amount of air leaking from the bottom to the top in conjunction with the door seal 115. In this case, the case seal 116 is partially formed only on the air passage toward the first discharge port 107. Therefore, at the position where the end of the mode door 106 faces the partition wall 105, the air flowing to the first discharge port 107 and the air flowing to the second discharge port 108 can be separated to further improve the air conditioning performance.

In addition, a tail seal 117 is further provided on a rotational shaft 118 of the mode door 106. For smooth rotation the mode door 106 within the case 101, an appropriate clearance is formed between the rotation axis 118 and the inner wall of the case 101. The tail seal 117 fills a gap between the rotational shaft 118 and the case 101, thereby allowing the mode door 106 to operate smoothly in rotation, and minimizing the backflow of the lower air inside the case 101 to the upper side.

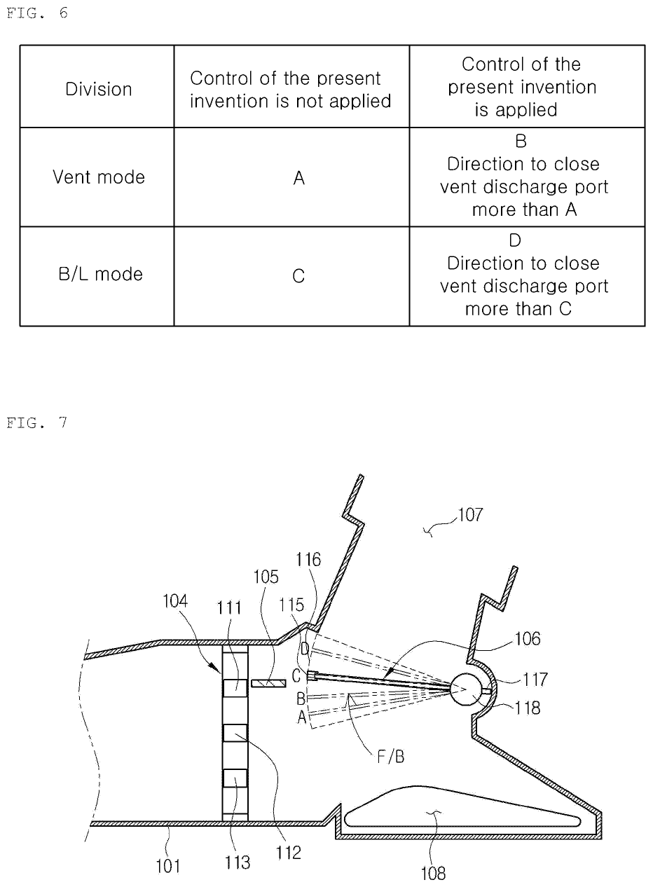

Meanwhile, in the air conditioning mode where air is simultaneously discharged to the first discharge port and the second discharge port, the control unit feeds back a drive voltage value to a driving part of the mode door 106 so that the mode door 106 is closed more toward the first discharge port 107 than in other air conditioning modes. Referring to FIG. 6, in the vent mode, the control unit controls the mode door 106 to a position B. A position A is the position where the control of the present invention is not applied, and the position B is the position where the control of the present invention is applied. The position B is in the direction of closing more toward the first discharge port 107 than the position A.

In addition, in the bi-level the control unit controls the mode door 106 to a position D. a position C is the position where the control of the present invention is not applied, and the position D is the position where the control of the present invention is applied. The position D is in the direction of closing more toward the first discharge port 107 than the position C. Furthermore, in modes (such as floor mode) other than the vent mode or the bi-level mode, the control unit controls the drive voltage value without feedback to the mode door 106.

As described above, in the vent mode or the bi-level mode, the mode door 106 is controlled to close more toward the first discharge port 107. Therefore, the rear air conditioner for a vehicle according to the present invention can improve the discharge temperature at the B-pillar side by reducing the amount of warm air heading to the console vent and relatively increasing the amount of warm air heading to the second discharge port 108. It was confirmed that, in the vent mode or bi-level mode, when only the bottom two rows of the electric heater 104 were operated (ON), temperature of the console vent slightly increased, but the temperature of the B-pillar vent significantly increased.

In summary, in the air conditioning mode where air is simultaneously discharged to both the first discharge port 107 and the second discharge port 108, only the heating parts of the electric heater 104 corresponding to the region near the second discharge port 108 operate. Accordingly, the control controls the heating region of the electric heater 104 differently depending on the air conditioning mode. Meanwhile, the plurality of discharge ports of the case 101 respectively have discharge ducts, and the lengths of the discharge ducts are formed differently from each other. The discharge ducts include a B-pillar duct 170, a floor duct, a console duct, etc.

That is, when air is discharged simultaneously through the plurality of discharge ports, the control unit controls only some region of the electric heater 104 to generate heat. In this instance, the heat generating region of the electric heater 104 is a region corresponding to the discharge port where the length of the discharge duct is relatively longer. That is, since the B-pillar duct 170 is formed longer than the console duct, the control unit controls only the lower region of the electric heater 104 corresponding to (or near) the second discharge port 108 to generate heat.

If the length of the discharge duct is long, significant heat loss occurs. So, in order to compensate for the heat loss, the control unit controls only some region of the electric heater 104 corresponding to the relatively longer vent to generate heat. Meanwhile, in the air conditioning mode where air is discharged through only one of the first discharge port 107 and the second discharge port 108, since there is no temperature difference between the upper region and the lower region, the entire electric heater 104 is controlled to be ON or OFF.

The control to generate heat only in some region of the electric heater 104 is performed when the external air temperature is below a specific temperature, the battery voltage is above a specific volt, the blower 110 is at a specific level or higher, and the target discharge temperature for the rear seat is above a specific temperature. In other words, the control unit performs the control to generate heat only in some region of the electric heater 104 only when all the conditions other than the air conditioning mode must be satisfied. Additionally, the control to generate heat only in some region of the electric heater 104 is released when any one of the following conditions is met: the external air temperature is above the specific temperature, the battery voltage is below the specific volt, the blower 110 is off (OFF) or at the lowest level, or the target discharge temperature for the rear seat is below the specific temperature.

The rear air conditioner for a vehicle according to the present invention has been described with reference to the embodiments shown in the drawings, but this is merely exemplary, and it should be understood that anyone skilled in the art can make various modifications and equivalent other embodiments from this. Therefore, the true technical protection scope should be determined by the technical idea of the attached patent claim scope.

What is claimed is:

1. A rear air conditioner for a vehicle, which is connected to a front air conditioner to supply conditioned air to a rear seat side in the vehicle, comprising:
a case of which one side is connected to the front air conditioner, and which includes a plurality of discharge ports formed at the other side to discharge air into the interior of the vehicle; and
an electric heater which is provided in the case to heat the air passing through the electric heater,
wherein the electric heater includes a plurality of operating regions, and the plurality of operating regions operate according to air conditioning modes.

2. The rear air conditioner according to claim 1, wherein the discharge ports include a first discharge port and a second discharge port,
wherein the electric heater includes a plurality of heating parts, and
wherein in the air conditioning mode where air is simultaneously discharged to the first discharge port and the second discharge port, only the heating parts of the electric heater corresponding to a region near the second discharge port is operated.

3. The rear air conditioner according to claim 1, wherein the discharge ports include a first discharge port and a second discharge port which is formed below the first discharge port,
wherein a backflow prevention means is provided to suppress that the air flowing toward the second discharge port downstream of the electric heater in an air flow direction flows back to the first discharge port side.

4. The rear air conditioner according to claim 3, wherein a partition wall is formed to extend in a direction parallel to the air flow direction at the rear end of the electric heater.

5. The rear air conditioner according to claim 4, wherein a mode door is provided inside the case to adjust the amount of air flowing to the first discharge port and the amount of air flowing to the second discharge port, and
wherein the partition wall is arranged between the electric heater and the mode door.

6. The rear air conditioner according to claim 5, wherein the partition wall is arranged above a middle portion of the electric heater in the vertical direction.

7. The rear air conditioner according to claim 5, wherein at a position where the end of the mode door faces the partition wall, the air passing through the electric heater is guided to the first discharge port and the second discharge port by the partition wall.

8. The rear air conditioner according to claim 3, wherein the case includes a mode door which adjusts the amount of air flowing to the first discharge port and the amount of air flowing to the second discharge port, and
wherein a control unit is provided to, in the air conditioning mode where air is simultaneously discharged to the first discharge port and the second discharge port, feedback a drive voltage value to a driving part of the mode door so that the mode door is closed more toward the first discharge port than in other air conditioning modes.

9. The rear air conditioner according to claim 3, wherein the case includes a mode door which adjusts the amount of air flowing to the first discharge port and the amount of air flowing to the second discharge port, and
wherein a door seal is provided along the perimeter of the mode door to suppress the flow of air flowing from the bottom to the top.

10. The rear air conditioner according to claim 9, further comprising:
a case seal which is provided on the side of the case to fill a gap between the case and the mode door,
wherein the case seal is partially formed only in the air passage directed to the side of the first discharge port.

11. The rear air conditioner according to claim 9, further comprising:
a tail seal which is provided on a rotational shaft of the mode door to fill a gap between the rotational shaft and the case.

12. The rear air conditioner according to claim 2, wherein in a vent mode or a bi-level mode, control is performed so that only some heating parts located at the bottom of the electric heater are operated, and
wherein the number of the operated heating parts is more than the number of non-operated heating parts.

13. The rear air conditioner according to claim 1, wherein a blower which blows air to the plurality of discharge ports is provided in the case, and the blower is arranged upstream of the electric heater in the air flow direction.

14. The rear air conditioner according to claim 1, wherein the electric heater is arranged in front of the plurality of discharge ports, and partially operates to heat only the air discharged to a specific discharge port among the plurality of discharge ports depending on the air conditioning mode.

15. A rear air conditioner for a vehicle, which is connected to a front air conditioner to supply conditioned air to a rear seat side in the vehicle, comprising:
a case of which one side is connected to the front air conditioner, and which includes a plurality of discharge ports formed at the other side to discharge air into the interior of the vehicle;
an electric heater which is provided in the case to heat the air passing through the electric heater; and
a control unit which controls a heating region of the electric heater differently according to air conditioning modes.

16. The rear air conditioner according to claim 15, wherein the plurality of discharge ports respectively have discharge ducts, and the lengths of the discharge ducts are formed to be different from each other.

17. The rear air conditioner according to claim 16, wherein the control unit controls to generate heat only in some region of the electric heater when air is simultaneously discharged to the plurality of discharge ports.

18. The rear air conditioner according to claim 17, wherein the heat generating region of the electric heater corresponds to the discharge port for which the length of the discharge duct is relatively long.

19. The rear air conditioner according to claim 17, wherein the control to generate heat only in some region of the electric heater is performed when an external air temperature is below a specific temperature, a battery voltage is above a specific volt, a blower is at a specific level or higher, and a target discharge temperature for the rear seat is above a specific temperature.

20. The rear air conditioner according to claim 19, wherein the control to generate heat only in some region of the electric heater is released when any one of the following conditions is met:
a case in which the external air temperature is above the specific temperature, a case in which the battery voltage is below the specific volt, a case in which the blower is off (OFF) or at the lowest level, or a case in which the target discharge temperature for the rear seat is below the specific temperature.
